(19) United States
(12) Patent Application Publication
(10) Pub. No.: US 2021/0100079 A1
(43) Pub. Date: Apr. 1, 2021

(54) LED LUMINAIRE MULTIPLEXING WITH CONSTANT CURRENT DRIVER

(71) Applicant: SIGNIFY HOLDING B.V., Eindhoven (NL)

(72) Inventors: Benjamin D. Vollmer, Manlius, NY (US); Isaac P. Dost, Syracuse, NY (US)

(21) Appl. No.: 16/589,835

(22) Filed: Oct. 1, 2019

(51) Int. Cl. H05B 33/08

(52) U.S. Cl. CPC H05B 33/0845; H05B 33/0815; H05B 33/0827

(57) ABSTRACT

A light emitting diode (LED) luminaire or other a system for emitting light includes a first LED string comprising one or more LEDs that are electrically connected in series. The system also includes one or more additional LED strings, each of which is electrically connected to the first LED string in parallel. The system also includes a constant current LED driver having an output that is electrically connected to inputs of the first LED string and each of the additional LED strings. The constant current driver will supply power to the first LED string and each of the additional LED strings. Each of the LED strings may include an LED string switch that is electrically connected in series with its corresponding LED string. Each LED string switch is configured to selectively switch its corresponding LED string on and off in response to signals from a controller.

### BACKGROUND

Light emitting diode (LED) luminaires typically include an LED source or multiple sets of LEDs connected together. LEDs are typically designed to run on low voltage, such as 12-24V, direct current (DC) electricity. For this reason, LED luminaires will have one or more LED drivers. LED drivers, which are sometimes also referred to as LED power supplies, are circuits that convert power from a relatively higher line voltage (such as 120V or 220V) alternating current (AC) source into low voltage direct current. In addition to rectifying AC current to DC current, LED drivers protect LEDs from current and voltage fluctuations caused by variabilities in the power source. LED drivers may be integral with an LED luminaire, or they may be external to the luminaire and electrically connected between an external power supply and the LEDs.

High power LEDs, such as those having power ratings of 1 watt (W) or higher, and which operate on input currents that range up to hundreds of milliamps (mA), are commonly used in luminaires. High-power LEDs can provide several advantages in luminaires as they have a long life, consume much less power than many other types of lamps, and exhibit good resistance to adverse environmental effects. High-power LEDs require a fixed input current, but can operate on a range of input voltages. Such LEDs therefore require a constant current driver, which supplies a designated output current with a range of output voltages.

In a typical LED luminaire, multiple drivers are needed to provide power to multiple LED strings or sources. To reduce the number of constant current drivers used in a luminaire having multiple LED strings, LED luminaires will typical share the load evenly between strings using resistive load balancing, which can be very difficult. This does not allow for individual control of each string, and it requires all strings to be either on or off at the same time.

This document describes methods and systems that are directed to solving at least some of the issues discussed above.

### SUMMARY

In various embodiments, a system for emitting light includes a first light emitting diode (LED) string comprising one or more LEDs that are electrically connected in series. The system also includes one or more additional LED strings, each of which is electrically connected to the first LED string in parallel. The system also includes a constant current LED driver having an output that is electrically connected to inputs of the first LED string and each of the additional LED strings. The constant current driver will supply power to the first LED string and each of the additional LED strings.

In some embodiments, the system also includes a driver-level switching device that is electrically connected in series between the output of the LED driver and the inputs of the LED strings. The driver-level switching device is configured to control overall brightness of the first LED string and the additional LED strings by applying pulse width modulation to control a duty cycle of the LED driver. Optionally, the driver-level switching device may comprise a single, p-channel field effect transistor (PFET). In some embodiments, the system includes a controller that is configured to control operation of the driver-level switching device.

In some embodiments, the system includes, for each of the LED strings, an LED string switch that is electrically connected in series with its corresponding LED string. Each LED string switch is configured to selectively switch its corresponding LED string on and off in response to signals from a controller. Optionally, each LED string switch comprises an n-channel field effect transistor (NFET). In some embodiments, the system includes a controller that is configured to control operation of each LED string switch.

In various embodiments, the LED strings may be components of an LED luminaire. The LED driver also may be a component of an LED luminaire, or it may be external to the luminaire.

In various embodiments, a method of controlling operation of a luminaire includes a controller operating an LED module that comprises a plurality of LED groups. Each of the LED groups comprises: (I) a first light emitting diode (LED) string comprising one or more LEDs that are electrically connected in series and a first LED string switch; (ii) one or more additional LED strings, each of which comprises an additional LED string switch and which is electrically connected to the first LED string in parallel; and (iii) a constant current LED driver having an output that is electrically connected to inputs of the first LED string and each of the additional LED strings. Operating the LED module comprises causing each of the LED string switches to selectively switch its corresponding LED string on and off over a duty cycle of the LED driver.

Optionally, the controller also may direct, to a driver-level switching device that is electrically connected between an output of the LED driver and inputs of each of the LED strings in an LED group, a signal that causes the driver-level signal to regulate the duty cycle of the LED driver using pulse width modulation. This in turn regulates brightness of light output by the LED strings.

Optionally, each of the LED strings is an element of an LED matrix. If so, when the controller causes each of the LED string switches to selectively switch its corresponding LED string on and off over a duty cycle of the LED driver, it may effectively regulate brightness of light output by the corresponding LED strings over the duty cycle.

Optionally, each of the LED strings is an element of an LED matrix. If so, then when the controller causes each of the LED string switches to selectively switch its corresponding LED string on and off over a duty cycle of the LED driver, it will effectively regulate brightness of light output by the corresponding LED strings over the duty cycle.

### BRIEF DESCRIPTION OF THE DRAWINGS

FIG. 1 illustrates an example LED luminaire such as may exist in the prior art.

FIGS. 2 and 3 illustrate common LED driver topologies as may exist in the prior art.

FIG. 4 illustrates a first embodiment of an LED driver topology according to the present disclosure.

FIG. 5 illustrates a method of using multiplexing to control LED strings of an LED luminaire having a circuit topology such as that of FIG. 4.

FIGS. 6A-6C illustrates a method of applying the multiplexing methods described in this document to an LED matrix.

### DETAILED DESCRIPTION

Terminology that is relevant to this disclosure includes:

In this document, the singular forms “a,” “an,” and “the” include plural references unless the context clearly dictates otherwise. The term “comprising” means “including, but not limited to.” Similarly, the term “comprises” means “includes, and is not limited to.” Unless defined otherwise, all technical and scientific terms used in this document have the same meanings as commonly understood by one of ordinary skill in the art.

In this document, the terms “lighting device,” “light fixture,” “luminaire” and “illumination device” are used interchangeably to refer to a device that includes a source of optical radiation such as one or more light emitting diodes (LEDs), light bulbs, ultraviolet light or infrared sources, or other sources of optical radiation. A lighting device will also include a housing, one or more electrical components for conveying power from a power supply to the device's optical radiation source, and optionally control circuitry. An “LED luminaire” is a lighting device that includes LEDs as an optical radiation source.

In this document, the term “electrically connected” means, with respect to two or more components, that a conductive path exists between the components so that electric current can flow from one of the components to the other, either directly or through one or more intermediary components.

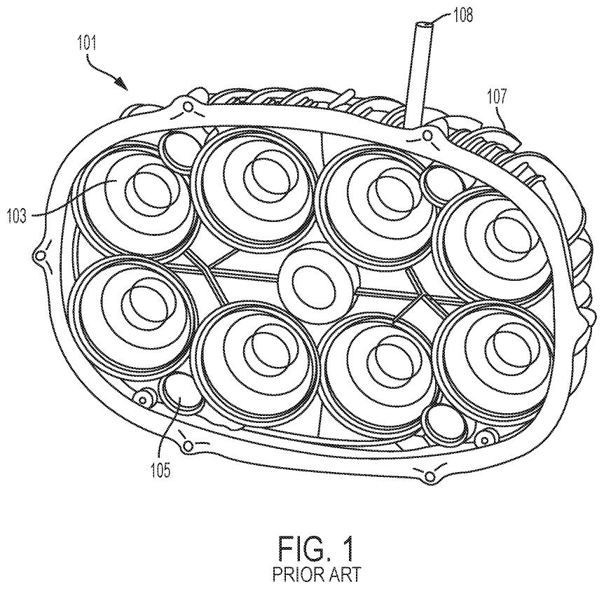

Referring to FIG. 1, an example lighting device 101 such as that which may exist in the prior art may include an optical radiation source, such as any number of lighting modules that include LEDs. In various embodiments, lighting device 101 will include a number of LED modules 103, 105 sufficient to provide a high intensity LED device. The lighting device 101 may include a housing 107 that holds electrical components such as a fixture controller, a power source, and wiring and circuitry to supply power and/or control signals to the LED modules. The lighting device 101 also may include communication components 108 such as a transceiver and antenna.

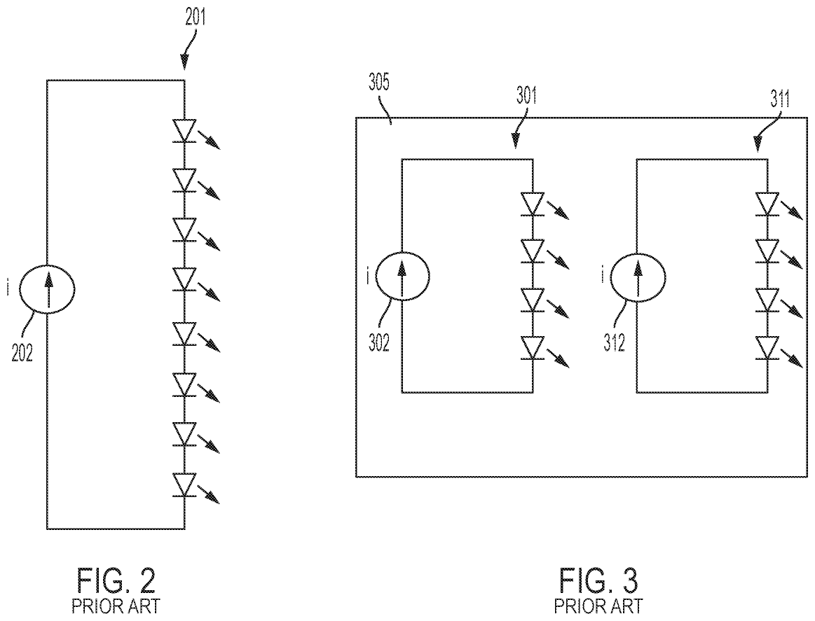

FIG. 2 illustrates a common topology for LED drivers of an LED luminaire as may exist in the prior art. As shown, an LED string 201 includes any number of LEDs electrically connected to each other in series. An LED driver 202 is electrically connected in parallel to the LED string 201 to provide power to the LED string 201. An LED driver is an electrical circuit that applies a voltage across an LED or string of LEDs to power the LED(s), thus acting as a power supply for the LEDs. An example LED driver is disclosed in U.S. Pat. No. 7,075,252 (“LED Driver Circuit”), the disclosure of which is incorporated into this document by reference. In a luminaire with high-power LEDs, the LED driver 202 may be a constant current driver, an example of which is disclosed in U.S. Pat. No. 8,723,449 (“Light Emitting Element Drive Circuit”), the disclosure of which is incorporated into this document by reference. FIG. 3 illustrates that in the prior art, an LED luminaire (represented by box 305) may include multiple LED strings 301, 311, each of which is powered by its own independently associated LED driver 302, 312.

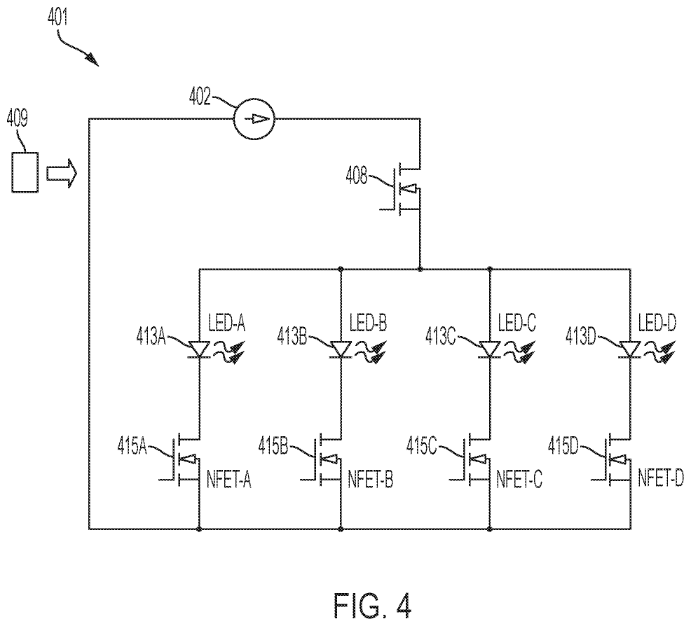

FIG. 4 illustrates an example LED driver circuit topology that helps address the problems described in the Background section above. In FIG. 4, multiple LED strings 413A-413D are electrically connected to the output of a single, constant current LED driver 402. Each LED string 413A-413D in the LED string group may include either a single LED or multiple LEDs connected in series. The number and types of LEDs in each string may be identical, or they may vary from string to string. Although FIG. 4 shows four LED strings connected in parallel, fewer or more LED strings may be used in the inventors' various contemplated embodiments.

Optionally, the brightness of the LEDs may be controlled by an external controller 409 that includes a processor and an output that directs a signal to a first switching device 408 that controls the duty cycle of the LED driver 402 via pulse width modulation (PWM). This document may refer to the first switching device 408 as a “driver-level” switching device to distinguish it from the LED-string-specific switching devices that will be described below, and also because it regulates output from the LED driver. The driver-level switching device may be a p-channel field effect transistor (PFET), another type of transistor, or any type of switch that is capable of using pulse width modulation to control power that passes through it. Methods of dimming and/or controlling brightness of LEDs using PWM are disclosed in, for example, U.S. Pat. No. 10,135,501 (“High Intensity LED Illumination Device with Automated Sensor-Based Control”), the disclosure of which is incorporated into this document by reference. Only one driver-level switching device is required to control brightness for any group of parallel-connected LED strings in this disclosure, although the inventors do not intend to limit the disclosure to single-switching-device embodiments, and embodiments with no such driver-level switching device are also included in the scope of this disclosure. The driver-level switching device 408 also may serve as an LED-group-wide on/off switch, as when switched off the driver-level switching device 408 will disconnect the LED group from its power supply.

In addition to the driver-level switching device that controls brightness of the LEDs, operation of each LED string 413A-413D may be multiplexed by a set of LED string switches 415A-415D. Each LED string (e.g., 413A) will include a dedicated LED string switch (e.g., 415A) that is connected in series with its corresponding LED string to selectively open or close the circuit formed by the LED string (e.g., 413A), driver-level switching device 408 and LED driver 402. The controller 409 is in communicative connection with each LED string switch 413A-413D to turn each LED string switch on during only a portion of the LED driver's duty cycle (as limited by the first switching device 408). In this way, only one of the connected LED strings 413A-413D will be “on” at any given time.

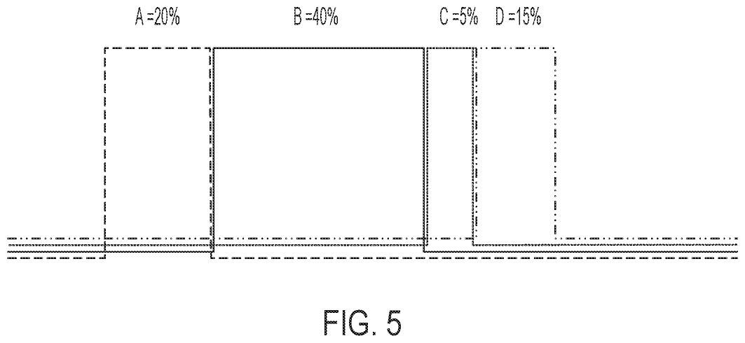

An example of this is shown in FIG. 5, which shows a method by which each of the four LED strings A-D are multiplexed over a duty cycle of the LED driver (which is limited to 80% in this example. Referring to FIGS. 4 and 5, LED string switch 415A will be on and LED string 413A will be illuminated during the first 20% of the LED driver's duty cycle. LED string switch 415B will be on and LED string 413B will be illuminated during the next 40% of the LED driver's duty cycle. LED string switch 415C will be on and LED string 413C will be illuminated during the next 5% of the LED driver's duty cycle. LED string switch 415D will be on and LED string 413D will be illuminated during the next 10% of the LED driver's duty cycle. During the final 20% of the LED driver's duty cycle all LEDs will be off due to PWM control by the driver-level switching device 408. (NOTE: In FIG. 5, the lowermost elements of each signal do not overlap, but this is only for purposes of illustration so that the reader of this document may visually see the operations of each of the four LED strings. In practice, when each LED string is “off,” its signal will be zero, and the “off” conditions for each of the four signals would be along the same horizontal line.)

Not all of the LED strings need to be switched on during each duty cycle. The LED string switches 415A-415D may selectively activate none, one, or two or more of the LED strings during any duty cycle. Just as the use of driver-level PWM control may limit the peak brightness of the LED group, the selective activation of individual LED strings 413A-413C within the group by the LED string switches will divide the total brightness among the active LED strings. In the example of FIG. 5, if maximum brightness is considered to be 100%, the relative brightnesses of each string would be 20% of maximum for LED string A, 40% of maximum for LED string B, 5% of maximum for LED string C, and 15% of maximum for LED string D.

While the example described above indicates that only one of the connected LED strings 413A-413D in the LED driver's LED string group will be “on” at any given time, the invention is not limited to such embodiments. Optionally, the controller may permit two or more of the LED string switches 415A-415D (and thus two or more of the connected LED strings 413A-413D) to be “on” at any given time. However, doing so will further decrease the brightness of each LED string that is on, as they must share the power output by the LED driver 402.

In the embodiments described above the constant current LED driver 402, first switching device 408, and/or the controller 409 may be integrated within the device that contains the LEDs. Alternatively, any or all of these elements may be a separate component that is electrically connected to the LED strings.

The embodiments described above are not limited to luminaires with a single LED driver. Any number of two or more drivers may be available in parallel to drive separate groups of LED strings, so long as at least one of the LED drivers is connected to two or more LED strings in a topology such as that shown in FIG. 4.

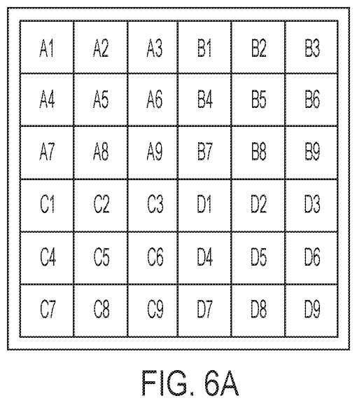

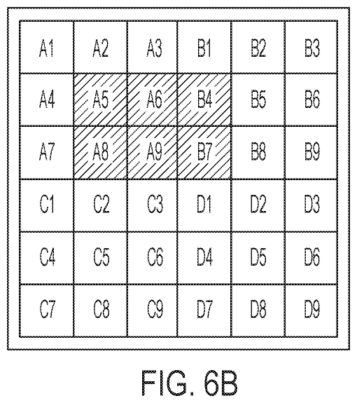

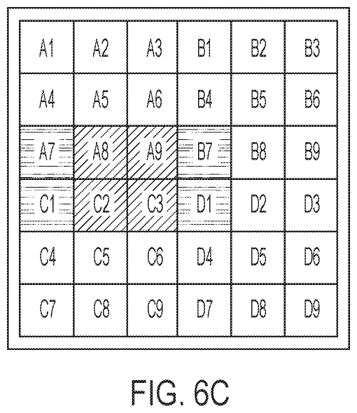

The topology and methods of operation described above may be implemented in a luminaire such as that shown in FIG. 1, or any other LED luminaire. In a luminaire 101 such as that of FIG. 1, each LED module 103, 105 may include a matrix (i.e., array) of LEDs. The luminaire's controller may direct the shape, size, brightness and/or direction of each LED module's light output by selectively controlling the LEDs within each array. FIG. 6 illustrates an example array with four quadrant. Each matrix element is labeled with a letter and number, indicating that it is part of a topology such as that shown in FIG. 4. The number corresponds to an LED driver (and in this case there are nine LED drivers), and the letter corresponds to an LED string that is connected to that LED driver in a topology such as that shown in FIG. 4.

In FIG. 6A, all LEDs are off, indicating that all of the LED string switches are off.

In FIG. 6B, the “A” LED strings have been switched on for LED drivers 5, 6, 8 and 9, while the “B” LED strings have been switched on for LED drivers 4 and 7.

In FIG. 6C, the “A” LED strings have been switched on for LED drivers 7, 8 and 9. The “B” LED string has been switched on for LED driver 7. The “C” LED strings have been switched on for LED drivers 1, 2 and 3, The “D” LED string has been switched on for LED driver 1. Note that because two LED strings have been switched on for drivers 7 and 2, the brightness of each of those LED strings will be less than that of the LED strings which are the only LED strings being activated by their respective driver. For example, LEDs strings A7 and B7 may operate at 50% of the brightness of LEDs strings A8 and A9. This is because the LED string drivers for LED strings A7 and B7 will switch on and off to alternate operation of each LED strong over the (optionally regulated) duty cycle of the LED driver), thus reducing the apparent intensity of each LED string.

The embodiments described above may be installed and included in the circuitry of an individual luminaire. Alternatively, the components may be part of a control system that is external to the luminaire. Examples of luminaires and control systems that the embodiments disclosed above may be used in include, for example, those described in U.S. Pat. No. 9,188,307, titled “High Intensity LED Illumination Device with Automated Sensor-Based Control”; U.S. Pat. No. 9,730,302, titled “System and Method for Control of Illumination Device”; and U.S. Pat. No. 9,800,431, titled “Controllers for Interconnected Lighting Devices”, the disclosures of which are all fully incorporated into this document by reference.

The features and functions described above, as well as alternatives, may be combined into many other different systems or applications. Various alternatives, modifications, variations or improvements may be made by those skilled in the art, each of which is also intended to be encompassed by the disclosed embodiments.

1. A system for emitting light, the system comprising:
a first light emitting diode (LED) string comprising one or more LEDs that are electrically connected in series;
one or more additional LED strings, each of which is electrically connected to the first LED string in parallel;
a constant current LED driver having an output that is electrically connected to inputs of the first LED string and each of the additional LED strings, wherein the constant current LED driver is for driving the first LED string and each of the additional LED strings from the constant current LED driver; and
a driver-level switching device that is electrically connected in series between the output of the constant current LED driver and the inputs of the LED strings,
wherein:
the driver-level switching device is configured to control overall brightness of the first LED string and the additional LED strings by applying pulse width modulation to control a duty cycle of the constant current LED driver such that:
the first LED string is illuminated for a first percentage of the duty cycle, and
at least one of additional LED strings is illuminated for a second percentage of the duty cycle, wherein the first percentage differs from the second percentage; and
wherein the first LED string and the one or more additional LED strings are Arranged in a plurality of arrays having two or more rows and columns of LEDs that are selectively controlled within each array.

2. (canceled)

3. The system of claim 1, wherein the driver-level switching device comprises a single, p-channel field effect transistor (PFET).

4. The system of claim 1, further comprising a controller that is configured to control operation of the driver-level switching device.

5. The system of claim 1, further comprising, for each of the LED strings:
an LED string switch that is electrically connected in series with its corresponding LED string;
wherein each LED string switch is configured to selectively switch its corresponding LED string on and off in response to signals from a controller.

6. The system of claim 5, wherein each LED string switch comprises an n-channel field effect transistor (NFET).

7. The system of claim 5, further comprising a controller that is configured to control operation of each LED string switch.

8. The system of claim 1, wherein the LED strings and the constant current LED driver are components of an LED luminaire.

9. The system of claim 1, wherein:
the LED strings are components of an LED luminaire; and
the constant current LED driver is positioned external to the LED luminaire.

10. A luminaire comprising:
a controller; and
a plurality of light emitting diode (LED) groups, each of which comprises;
a first LED string comprising one or more LEDs that are electrically connected in series,
one or more additional LED strings, each of which is electrically connected to the first LED string in parallel,
a constant current LED driver having an output that is electrically connected to inputs of the first LED string and each of the additional LED strings, wherein the constant current LED driver is for driving the first LED string and each of the additional LED strings from the constant current LED driver; and
a driver-level switching device that is electrically connected in series between the output of the constant current LED driver and the inputs of the LED strings,
wherein the driver-level switching device is configured to control overall brightness of the first LED string and the additional LED strings by applying pulse width modulation to control a duty cycle of the constant current LED driver in response to signals from the controller such that:
the first LED string is illuminated for a first percentage of the duty cycle; and
at least one of additional LED strings is illuminated for a second percentage of the duty cycle, wherein the first percentage differs from the second percentage;
wherein the first LED string and the one or more additional LED strings are arranged in a plurality of arrays having two or more rows and columns of LEDs that are selectively controlled within each array.

11. (canceled)

12. The luminaire of claim 10, wherein the driver-level switching device comprises a single, p-channel field effect transistor (PFET).

13. The luminaire of claim 10, wherein each of the LED strings comprises
an LED string switch that is electrically connected in series with its corresponding LED string,
wherein each LED string switch is configured to selectively switch its corresponding LED string on and off in response to signals from the controller.

14. The luminaire of claim 13, wherein each LED string switch comprises an n-channel field effect transistor (NFET).

15. The luminaire of claim 13, wherein:
the luminaire comprises an LED module having an LED matrix;
the LED matrix comprises the LEDs of the LED strings of each of the LED groups; and
the controller is operable to selectively control the LEDs of the LED matrix by controlling the LED string switches.

16. A method of controlling operation of a luminaire, the method comprising:
by a controller, operating a light emitting diode (LED) module that comprises a plurality of LED groups, each of which comprises:
a first LED string comprising one or more LEDs that are electrically connected in series and a first LED string switch,
one or more additional LED strings, each of which comprises an additional LED string switch and which is electrically connected to the first LED string in parallel, and
a constant current LED driver having an output that is electrically connected to inputs of the first LED string and each of the additional LED strings, wherein the constant current LED driver is for supplying power to the first and the additional LED strings,
wherein operating the LED module comprises causing each of the LED string switches to selectively switch its corresponding LED string on and off over a duty cycle of the constant current LED driver such that:
the first LED string is illuminated for a first percentage of the duty cycle, and
at least one of additional LED strings is illuminated for a second percentage of the duty cycle, wherein the first percentage differs from the second percentage; and
wherein the first LED string and the one or more additional LED strings are arranged in a plurality of arrays having two or more rows and columns of LEDs that are selectively controlled within each array.

17. The method of claim 16, further comprising, by the controller:
directing, to a driver-level switching device that is electrically connected between an output of the constant current LED driver and inputs of each of the LED strings in an LED group, a signal that causes the driver-level signal to regulate the duty cycle of the constant current LED driver using pulse width modulation, which in turn regulates brightness of light output by the LED strings.

18. The method of claim 16 wherein:
each of the LED strings is an element of an LED matrix; and
causing, by the controller, each of the LED string switches to selectively switch its corresponding LED string on and off over a duty cycle of the constant current LED driver effectively regulates brightness of light output by the corresponding LED strings over the duty cycle.

19. The method of claim 16, wherein:
each of the LED strings is an element of an LED matrix;
causing, by the controller each of the LED string switches to selectively switch its corresponding LED string on and off over a duty cycle of the constant current LED driver effectively regulates brightness of light output by the corresponding LED strings over the duty cycle; and
the method further comprises directing, by the controller to a driver-level switching device that is electrically connected between an output of the constant current LED driver and the plurality of LED groups, a signal that causes the driver-level signal to regulate the duty cycle of the constant current LED driver using pulse width modulation, which in turn further regulates brightness of light output by the corresponding LED strings.

20. The method of claim 16, in which less than all of the LED strings are switched on during each duty cycle.

21. (canceled)

22. (canceled)

23. The system of claim 1, in which the driver-level switching device is configured to control overall brightness of the first LED string and the additional LED strings by applying pulse width modulation to control that duty cycle of the LED driver such that less than all of the LED strings are switched on during each duty cycle.

24. (canceled)

25. The luminaire of claim 10, in which the driver-level switching device is configured to control overall brightness of the first LED string and the additional LED strings by applying pulse width modulation to control that duty cycle of the LED driver such that less than all of the LED strings are switched on during each duty cycle.
